(19) United States
(12) Patent Application Publication
(10) Pub. No.: US 2025/0012376 A1
(43) Pub. Date: Jan. 9, 2025

(54) FLOW RATE CONTROL DEVICE AND ZERO POINT ADJUSTMENT METHOD FOR PIEZO VALVE

(71) Applicant: FUJIKIN INCORPORATED, Osaka (JP)

(72) Inventors: Toru HIRAI, Osaka-shi (JP); Kaoru HIRATA, Osaka-shi (JP); Katsuyuki SUGITA, Osaka-shi (JP)

(73) Assignee: FUJIKIN INCORPORATED, Osaka (JP)

(21) Appl. No.: 18/755,314

(22) Filed: Jun. 26, 2024

(30) Foreign Application Priority Data
Jul. 5, 2023 (JP) 2023-111053

(51) Int. Cl. F16K 37/00; F16K 7/14; F16K 31/00

(52) U.S. Cl. CPC F16K 37/0041; F16K 7/14; F16K 31/007

(57) ABSTRACT

A flow rate control device includes a piezo valve having a metal diaphragm valve element that is opened and closed by a piezo actuator, a strain sensor for detecting a displacement amount of the piezo actuator, and a control circuit for receiving a detection signal of the strain sensor and controlling a drive voltage of the piezo actuator, wherein the control circuit is configured so as, by applying a positive drive voltage one or more times and then applying a negative drive voltage a plurality of times to the piezo actuator at a desired timing, to bring an amount of strain detected by the strain sensor close to zero when no drive voltage is applied to the piezo actuator.

### TECHNICAL FIELD

The present invention relates to a flow rate control device and a method of zero-point adjustment for a piezo valve, and more particularly, to a flow rate control device and a method of zero-point adjustment for a piezo valve used in semiconductor manufacturing equipment, a chemical plant, and the like.

### BACKGROUND ART

In semiconductor manufacturing equipment and a chemical plant, various types of flow meters and flow rate control devices are used for controlling a flow rate of a material gas or an etching gas. A flow rate control device generally includes a control valve for controlling the flow rate. As a control valve, a piezo element driven valve (piezo valve) configured to open and close a metal diaphragm valve element by a piezo actuator is known. The piezo valve is disclosed in detail in Patent Document 1 for example.

Although the piezo actuator can operate at a relatively high speed, an elongation of the piezo actuator is not strictly proportional to an magnitude of a drive voltage due to hysteresis characteristic and creep phenomenon. Therefore, a piezo valve provided with a strain sensor for measuring displacement of the piezo actuator is known, in which the drive voltage is feedback-controlled based on a strain signal (displacement output) of the strain sensor to control a valve opening degree at a high speed and with high accuracy (Patent Documents 2 and 3, etc.).

FIG. 1 is a graph showing a drive voltage and a displacement output of a strain sensor when the drive voltage is applied to a piezo actuator to control a valve opening degree without feedback control of the drive voltage based on the displacement output of the strain sensor in a normally closed piezo valve, and FIGS. 2 and 3 are enlarged views showing a part surrounded by a dashed-dotted line in FIG. 1 by changing the scale. FIG. 2 shows that the displacement output of the strain sensor fluctuates due to the creep phenomenon of the piezo element even when the drive voltage of the piezo actuator is stable. FIG. 3 shows that the displacement output of the strain sensor when commanding the drive voltage of the piezo actuator to 0V does not become zero due to the influence of hysteresis.

FIG. 4 is a graph showing a drive voltage and a displacement output of a strain sensor when the drive voltage of the piezo actuator is controlled based on the displacement output of the strain sensor in the normally closed piezo valve, and FIGS. 5 and 6 are enlarged views showing a part surrounded by a dashed-dotted line in FIG. 4 by changing the scale. FIG. 5 shows that the fluctuation of the displacement output due to creep phenomenon is suppressed by overshooting the drive voltage. FIG. 6 shows a condition in which a negative voltage is applied to the piezo actuator to control the drive voltage so that the displacement output becomes a set value (0V) in order to suppress the fluctuation of the displacement output due to hysteresis as shown in FIG. 3.

The piezo valve having a strain sensor can accurately control the opening and closing state and has high responsivity, therefore can be suitably used to pulse supply a gas at a desired flow rate in applications where a high-speed (very short period) pulse control signal is provided, such as an ALD (Atomic Layer Deposition) process or an ALE (Atomic Layer Etching) process.

### RELATED DOCUMENTS

### Patent Literatures

[Patent literature 1] Japanese Patent Laid-Open Publication No. JP2007-192269

[Patent literature 2] International Publication No. WO2018/123852

[Patent literature 3] International Publication No. WO2019/107215

### SUMMARY OF INVENTION

### Technical Problem

However, if the control of applying a negative voltage to the piezo actuator (also referred to as strain control) is continued as shown in FIG. 6 in order to suppress the fluctuation of the displacement output due to hysteresis as described above, the valve opening degree continues to change little by little, sometimes flow rate may not be controlled accurately.

Further, referring to the hysteresis characteristic model of the piezo actuator in FIG. 7, a (0, 0) point of the applied voltage 0V and the displacement amount of 0 μm in FIG. 7 is an indefinite point that is not determined by the assembling of the piezo actuator, the environmental temperature, and the like. If the position of the initial strain zero is indefinite, the zero-point adjustment for correcting the strain cannot be performed, and the (0, 0) point cannot be used as accurate displacement information to control the valve opening degree.

Therefore, a main object of the present invention is to provide a flow rate control device and a zero-point adjustment method for a piezo valve that is able to cancel the influence of hysteresis characteristic and creep phenomenon, and obtaining a reproducible strain zero position (zero-point position).

### Solution to Problem

In order to achieve the above object, a flow rate control device according to an embodiment of the present invention includes a piezo valve having a metal diaphragm valve element that is opened and closed by a piezo actuator, a strain sensor for detecting a displacement amount of the piezo actuator, and a control circuit for receiving a detection signal of the strain sensor and controlling a drive voltage of the piezo actuator, wherein the control circuit is configured so as, by applying a positive drive voltage one or more times, and then applying a negative drive voltage a plurality of times to the piezo actuator at a desired timing, to bring an amount of strain detected by the strain sensor close to zero when no drive voltage is applied to the piezo actuator. The plurality of times of negative drive voltage may be applied while gradually increasing the voltage.

Further, another embodiment of the present invention is a zero-point adjustment method for a piezo valve including a metal diaphragm valve element that is opened and closed by a piezo actuator. The method includes: detecting a displacement amount of the piezo actuator by a strain sensor, applying a positive drive voltage one or more times, and then applying a negative drive voltage a plurality of times to the piezo actuator to bring an amount of strain detected by the strain sensor close to zero when no drive voltage is applied to the piezo actuator. The plurality of times of negative drive voltage may be applied while gradually increasing the voltage.

### Effect of Invention

According to the embodiments of the present invention, it is possible to cancel the influence of hysteresis characteristic and creep phenomenon, and to obtain a reproducible strain zero position (zero-point position).

### BRIEF DESCRIPTION OF DRAWINGS

FIG. 1 is a graph showing a drive voltage of a piezo valve and a displacement output of a strain sensor.

FIG. 2 is a graph showing a part of FIG. 1 in an enlarged scale.

FIG. 3 is a graph showing another part of the graph of FIG. 1 in an enlarged scale.

FIG. 4 is a graph showing a drive voltage of the piezo valve and a displacement output of the strain sensor.

FIG. 5 is a graph showing a part of the graph of FIG. 4 in an enlarged scale.

FIG. 6 is a graph showing another part of the graph of FIG. 4 in an enlarged scale.

FIG. 7 is a graph showing the hysteresis characteristic of a piezo element.

FIG. 8 is a schematic diagram showing an embodiment of a flow rate control device according to the present invention.

FIG. 9 is a graph showing a time course of a drive voltage and a strain output by zero-point adjustment of a piezo valve according to an embodiment of the present invention.

FIG. 10 is a graph showing the graph of FIG. 9 in an enlarged scale.

FIG. 11 is a graph showing the time course of a drive voltage and a strain output by zero-point adjustment of the piezo valve according to another embodiment of the present invention.

FIG. 12 is a graph showing the graph of FIG. 11 in an enlarged scale.

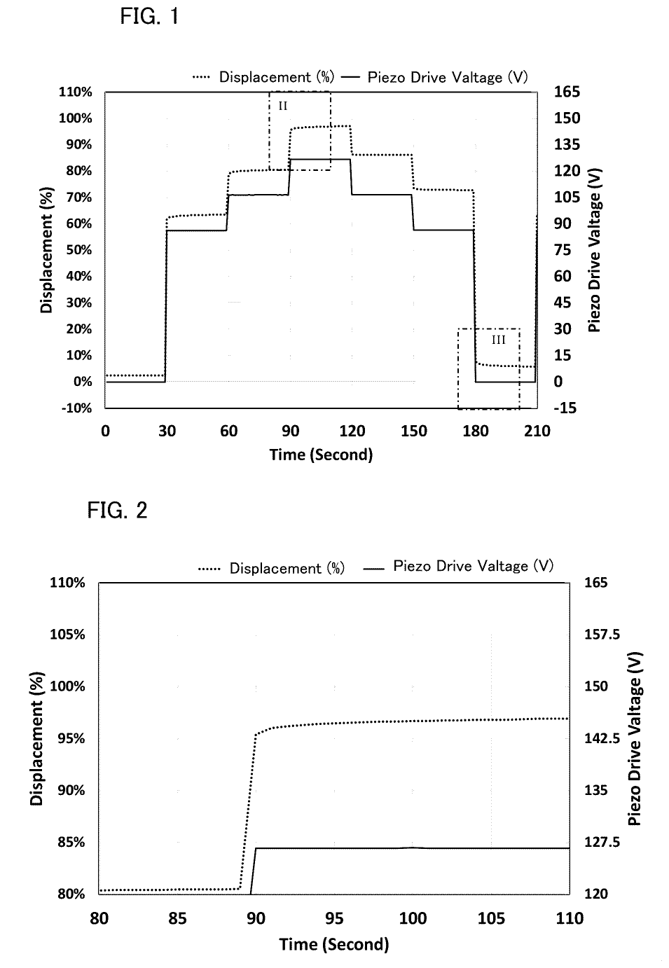

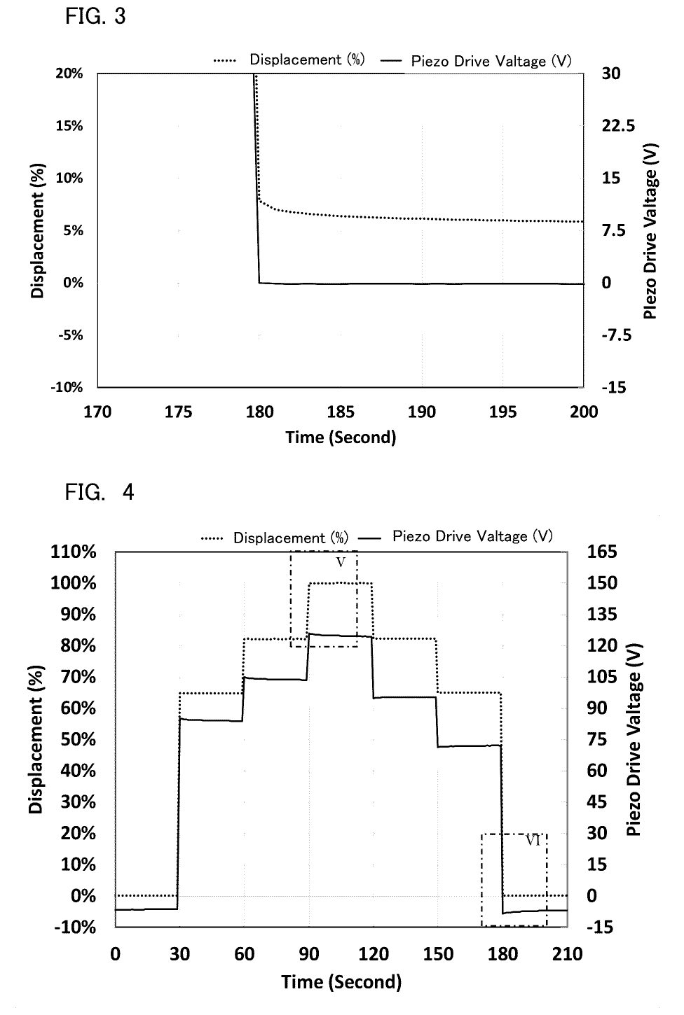

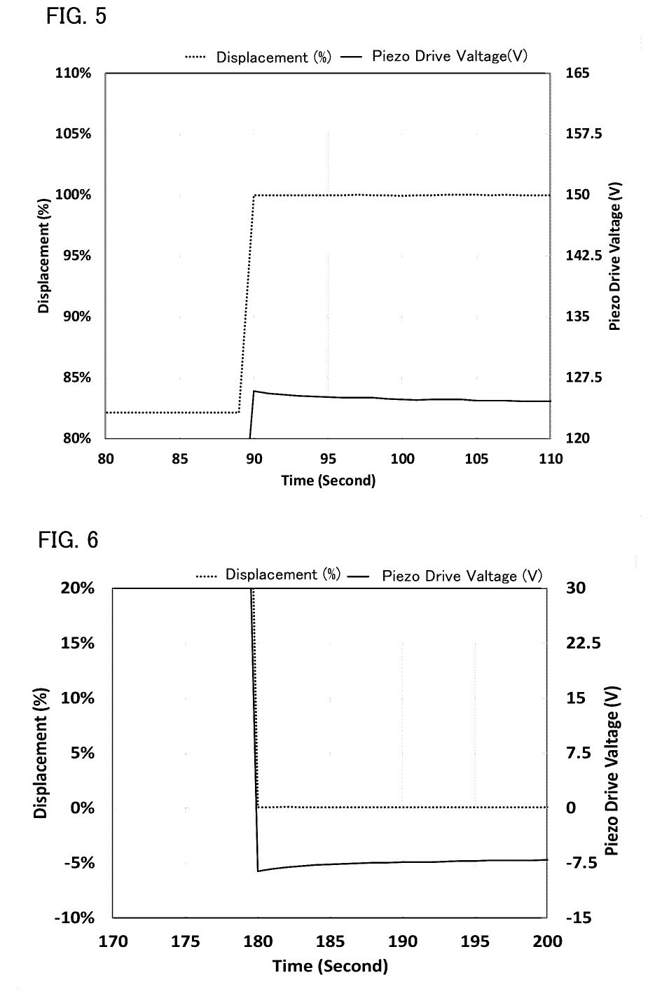

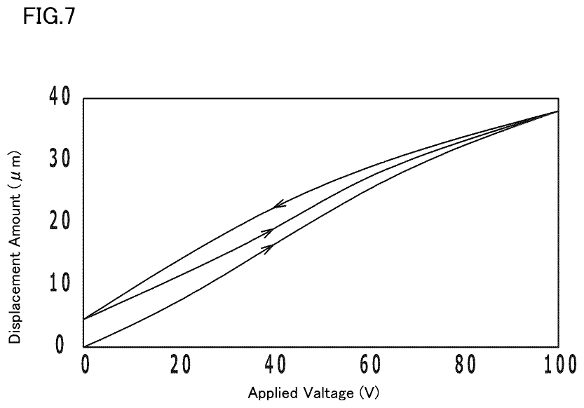

### DESCRIPTION OF EMBODIMENTS

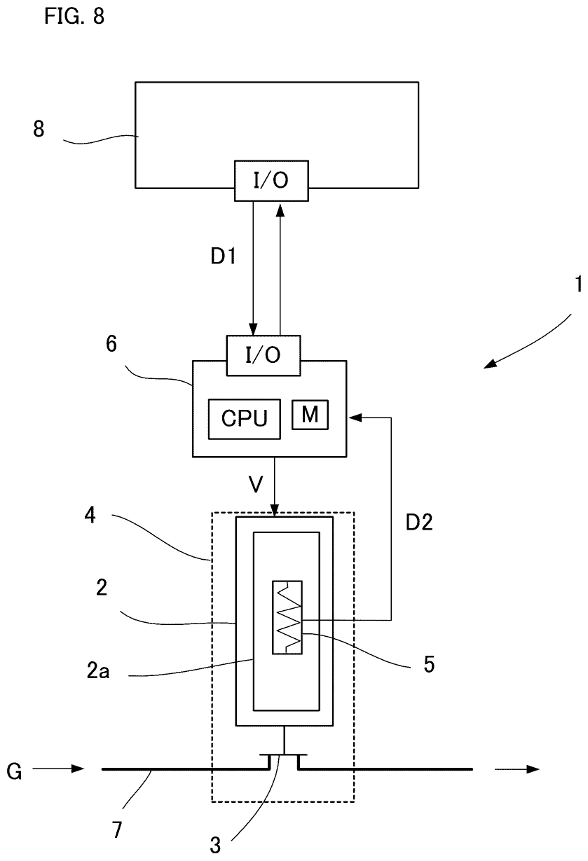

Embodiments of the flow rate control device according to the present invention will be described below with reference to FIGS. 8 to 12.

Referring to FIG. 8, the flow rate control device 1 includes a piezo valve 4 having a metal diaphragm valve element 3 that is opened and closed by a piezo actuator 2, a strain sensor 5 for detecting a displacement amount of the piezo actuator 2, and a control circuit 6 for receiving a detection signal from the strain sensor 5 and controlling a drive voltage of the piezo actuator 2. The piezo actuator 2 is displaced by expansion and contraction of the piezo element 2a in accordance with the drive voltage.

The metal diaphragm valve element 3 is interposed in a flow path 7, and opens and closes the flow path 7 in accordance with the displacement actuation of the piezo actuator 2. The valve opening degree of the metal diaphragm valve element 3 is controlled by controlling the displacement amount of the piezo actuator 2. For example, A fluid G, which is a pressure-regulated process gas, is supplied from an upstream side of the flow path 7, and a downstream side of the flow path 7 is connected to a process chamber (not shown) of semiconductor manufacturing equipment. A vacuum pump is connected to the process chamber, and typically the pressure-regulated fluid G is supplied to the process chamber in a state where the inside of the process chamber is evacuated.

As the piezo actuator 2, for example, products sold by NTK CERATEC, etc. can be utilized. The piezo actuator 2 may be constituted of a plurality of piezo elements accommodated and stacked in a cylindrical casing. As the metal diaphragm valve element 3, a self-elastic return type metal diaphragm valve element formed of a thin plate such as nickel-chromium alloy steel may be suitably used. A specific structure of the piezo valve 4 is known from JP2007-192269 etc., and thus a detailed description thereof will be omitted.

The strain sensor 5 may be directly attached to the piezo element 2a by an adhesive or the like. As the strain sensor 5, for example, a KFR-02N or a KFGS-1, KFGS-3 manufactured by KYOWA ELECTRONIC INSTRUMENTS CO., LTD. can be employed. Note that the strain sensor 5 can also be provided on an outer side of the casing for housing the piezo element 2a, as disclosed in WO 2018/123852 for example.

The control circuit 6 may be built in the flow rate control device 1, or may be provided outside the flow rate control device 1. The control circuit 6 typically comprises a CPU, a memory (storage device) M such as ROM or RAM, an A/D converter, and the like, the control circuit 6 may also include a computer program configured to perform flow rate control operations described below. The control circuit 6 can be realized by a combination of hardware and software.

The control circuit 6 amplifies and extracts a minute resistance change of the strain gauge constituting the strain sensor 5 as a voltage change by a Wheatstone bridge circuit, and converts the amount of strain into a voltage from a certain relationship between the extracted voltage change and the strain. The converted amount of strain corresponds to the displacement amount of the piezo actuator 2, and the displacement amount of the piezo actuator 2 corresponds to the valve opening degree of the metal diaphragm valve element 3.

When controlling the flow rate of the fluid G (flow rate control mode), the control circuit 6 feedback-controls the drive voltage V of the piezo actuator 2 so that the difference between a set displacement D1, which is sent from an external device (for example, semiconductor manufacturing equipment) 8, and a displacement amount (amount of strain) of the piezo actuator 2, which is obtained from a detection signal D2 of the strain sensor 5, becomes zero. Thereby, the valve opening degree of the metal diaphragm valve element 3 can be maintained at a predetermined opening degree, and the flow rate of the fluid G passing through the flow path 7 can be maintained at a predetermined value.

The control circuit 6 is able to execute a sequence control for performing the zero-point adjustment of the strain sensor 5 (hereinafter, also referred to as a zero-point adjustment mode) at a desired timing (for example, when the number of times of opening and closing the piezo valve reaches a predetermined number of times (for example, 10 million times) or at a time of maintenance, or the like). A sequence program for executing the sequence control in the zero-point adjustment mode can be stored in advance in the memory M incorporated in the control circuit 6 or an external storage device. Switching from the control mode of controlling the flow rate to the zero-point adjustment mode can be manually switched or automatically switched by the program.

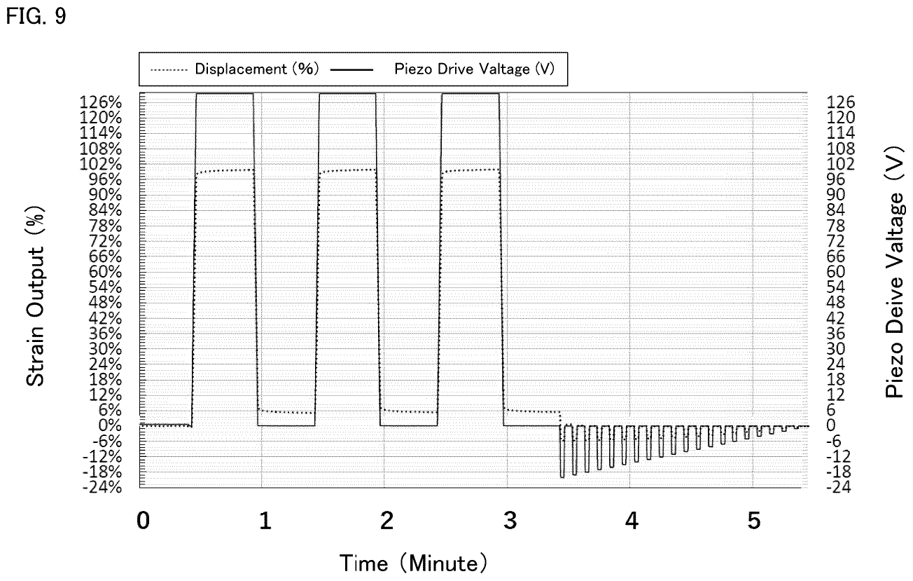

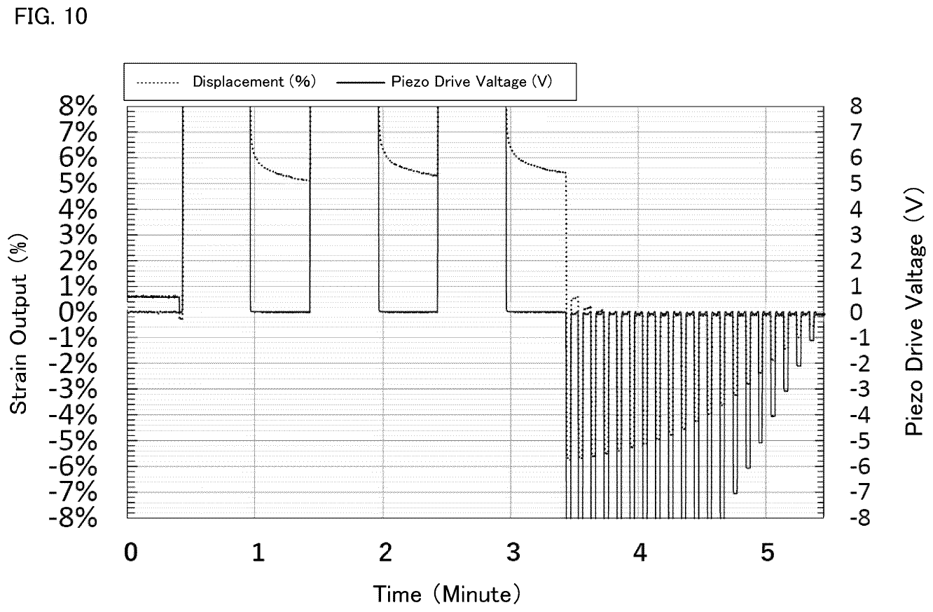

FIG. 9 is a graph showing a change in the amount of strain (strain output) in one embodiment in which the sequence control in the zero-point adjustment mode is performed in a normally closed piezo valve. In this case, for example, the strain output (amount of strain) of the strain sensor, when applying a positive drive voltage 130V, is set to be 100% strain output. FIG. 10 is a graph by enlarging the scale of FIG. 9. In the example of the zero-point adjustment mode shown in FIGS. 9 and 10, a positive drive voltage is applied to the piezo actuator 2 for three times and then a negative drive voltage is applied a plurality of times while gradually increasing the voltage. Specifically, 130V (30 seconds)→0V (30 seconds) are repeated for three times and then a negative drive voltage is applied a plurality of times in the following sequence. −20V (2 seconds)→0V (4 seconds)→−19V (2 seconds)→0V (4 seconds)→−18V (2 seconds)→0V (4 seconds)→−17V (2 seconds)→0V (4 seconds)→−16V (2 seconds)→0V (4 seconds)→−15V (2 seconds)→0V (4 seconds)→−14V (2 seconds)→0V (4 seconds)→−13V (2 seconds)→0V (4 seconds)→−12V (2 seconds)→0V (4 seconds)→−11V (2 seconds)→0V (4 seconds)→−10V (2 seconds)→0V (4 seconds)→−9V (2 seconds)→0V (4 seconds) −8V (2 seconds)→0V (4 seconds)→−7V (2 seconds)→0V (4 seconds)→−6V (2 seconds)→0V (4 seconds)→−5V (2 seconds)→0V (4 seconds)→−4V (2 seconds)→0V (4 seconds)→−3V (2 seconds)→0V (4 seconds)→−2V (2 seconds)→0V (4 seconds)→−1V (2 seconds)→0V (end).

Note that, prior to executing the sequence control of the zero-point adjustment mode, that is, in the period of 0 to 30 seconds in FIG. 9, the strain control is performed by applying a positive drive voltage of about 0.3V to bring the strain amount to 0 (%). In the drive voltage (strain control voltage) at the time of the strain control, when the drive voltage is zero, the strain control is performed so as to apply a positive strain control voltage when the output (amount of strain) of the strain sensor is negative, and to apply a negative strain control voltage when the output of the strain sensor is positive.

FIG. 9 and FIG. 10 show that even when the applied voltage is brought to 0V after a positive drive voltage (130V) is applied, the amount of strain of the piezo element 2a remains about 5 to 6% due to the effect of hysteretic characteristic and creeping phenomenon. Then, FIGS. 9 and 10 show that, after applying the positive drive voltage (130V) a plurality of times, by applying a negative drive voltage a plurality of times while gradually increasing the voltage, the amount of strain gradually converges and approaches zero, finally the amount of strain becomes almost 0 (%) when the drive voltage is 0 (V). Therefore, by performing the sequence of the above zero-point adjustment, it is possible to cancel the residual strain caused by hysteresis characteristic and creep-phenomenon and to bring the amount of strain to almost zero at the drive voltage 0V.

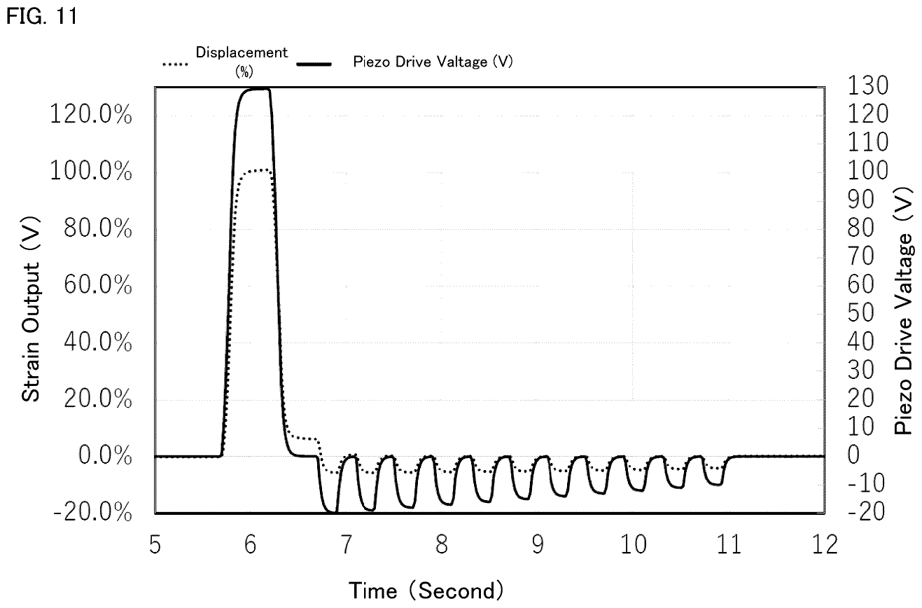

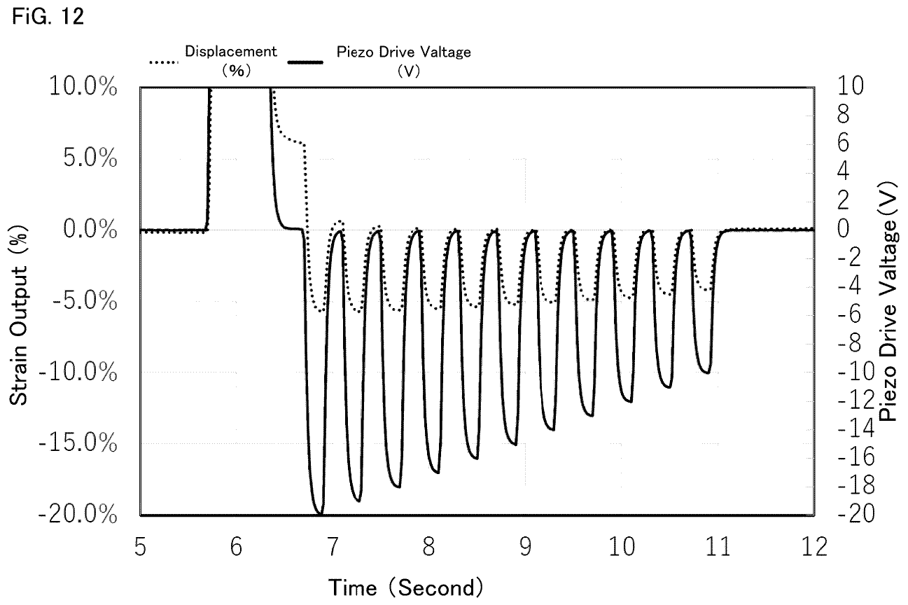

FIG. 11 is a graph showing results of performing a sequence of zero-point adjustment in a normally closed piezo valve, in which a positive drive voltage 130V is applied for a duration of 0.5 seconds for one time, and a negative drive voltage from −20V to −10V is applied while gradually increasing by 1V. FIG. 12 is a graph of FIG. 11 in an enlarged scale. In this zero-point adjustment mode, −20V→0V→−19V→0V→−18V→0V→−17V→0V→−16V→0V→−15V→0V→−14V→0V→−13V→0V→−12V→0V→−11V→0V→−10V→0V performed in a sequence in 5 seconds. The graphs in FIGS. 11 and 12 show that the effect of hysteresis characteristic and creep phenomenon can be cancelled and the amount of strain at the drive voltage 0V can be reduced to approximately zero in an adjustment duration of about 5.5 seconds. In the sequence of the zero-point adjustment mode shown in the graph of FIG. 9, the sequence execution time, i.e. the zero-point adjustment time, was about 300 seconds.

In the sequence of executing the zero-point adjustment mode, the applied voltage, the number of applied times, and the applied duration of the positive drive voltage, and the applied voltage, the number of applied times, and the applied duration of the negative drive voltage can be appropriately set by changing parameters of the control program, and by appropriately changing these parameters, it is possible to shorten the duration of executing the sequence of the zero-point adjustment mode, i.e. the zero-point adjustment duration. Further, the embodiment shows the example of a pattern in which a negative drive voltage is applied a plurality of times while being gradually increased, however, other patterns, such as applying a same voltage a plurality of times, may be adopted.

The present invention is applicable not only to a normally closed type piezo valve, but also to a normally open type piezo valve. The present invention is not construed as being limited to the above-mentioned embodiments, and various modifications are possible within a range that does not depart from the spirit of the present invention.

### REFERENCE SIGNS LIST

1 Flow rate control device
2 Piezo actuator
2a Piezo element
3 Metal diaphragm valve element
4 Piezo valve
5 Strain sensor
6 Control circuit
G Fluid

1. A flow rate control device comprising:
a piezo valve including a metal diaphragm valve element that is opened and closed by a piezo actuator;
a strain sensor for detecting a displacement amount of the piezo actuator;
a control circuit for receiving a detection signal of the strain sensor and controlling a drive voltage of the piezo actuator,
wherein the control circuit is configured so as, by applying a positive drive voltage one or more times and then applying a negative drive voltage a plurality of times to the piezo actuator at a desired timing, to bring an amount of strain detected by the strain sensor close to zero when no drive voltage is applied to the piezo actuator.

2. The flow rate control device according to claim 1, wherein the negative drive voltage is applied while gradually increasing the voltage.

3. A zero-point adjustment method for a piezo valve comprising a metal diaphragm valve element that is opened and closed by a piezo actuator, comprising:
detecting a displacement amount of the piezo actuator by a strain sensor;
applying a positive drive voltage one or more times, and then applying a negative drive voltage a plurality of times to the piezo actuator to bring an amount of strain detected by the strain sensor to zero when no drive voltage is applied to the piezo actuator.

4. A zero-point adjustment method for the piezo valve according to claim 3, wherein the negative drive voltage is applied while gradually increasing the voltage.
